(19) United States
(12) Patent Application Publication
(10) Pub. No.: US 2024/0416845 A1
(43) Pub. Date: Dec. 19, 2024

(54) MOUNTING SYSTEMS FOR SECURING COMPONENTS TO VEHICLE BODY PANELS

(71) Applicant: FORD GLOBAL TECHNOLOGIES, LLC, Dearborn, MI (US)

(72) Inventors: Lee Mitchell TOME, Windsor (CA); John ORISCHAK, Dearborn, MI (US); Joshua WHEELER, Trenton, MI (US); Brian SCHABEL, Northville, MI (US); Robert Lee GAGE, Southfield, MI (US)

(21) Appl. No.: 18/333,928

(22) Filed: Jun. 13, 2023

(51) Int. Cl. B60R 11/00

(52) U.S. Cl. CPC B60R 11/00; B60R 2011/004; B60R 2011/0063

(57) ABSTRACT

Mounting systems are described for mounting a vehicle component to an interior surface of a vehicle body panel. An exemplary mounting system may include a locking mount that can be secured to the interior surface of the vehicle body panel by a structural patch. The vehicle component may be an exciter that can be secured to the locking mount to achieve positive contact relative to the vehicle body panel and achieve desired acoustic requirements for broadcasting audio signals.

### TECHNICAL FIELD

This disclosure relates to motor vehicles, and more particularly to mounting systems for mounting components to vehicle body panels.

### BACKGROUND

Automotive vehicle bodies include a multitude of body panels. Vehicle components are often mounted to the body panels.

### SUMMARY

A vehicle assembly according to an exemplary aspect of the present disclosure includes, among other things, a mounting system including a locking mount and a structural patch, and a vehicle component mounted to the locking mount.

In a further non-limiting embodiment of the foregoing vehicle assembly, the mounting system is secured to an interior surface of a vehicle body panel.

In a further non-limiting embodiment of either of the foregoing vehicle assemblies, the vehicle body panel is an outer panel of a front fender or a rear quarter panel.

In a further non-limiting embodiment of any of the foregoing vehicle assemblies, the vehicle component is an exciter.

In a further non-limiting embodiment of any of the foregoing vehicle assemblies, the locking mount includes a base and a collar that protrudes outwardly from the base.

In a further non-limiting embodiment of any of the foregoing vehicle assemblies, the vehicle component includes a mounting base having a mating flange that is configured to engage a cam tab of the collar.

In a further non-limiting embodiment of any of the foregoing vehicle assemblies, the vehicle component includes a mounting base having a mounting flange that includes a lip that is configured to engage a flexible prong of the collar.

In a further non-limiting embodiment of any of the foregoing vehicle assemblies, the base is embedded within the structural patch.

In a further non-limiting embodiment of any of the foregoing vehicle assemblies, the structural patch is a mastic patch or an adhesive patch.

In a further non-limiting embodiment of any of the foregoing vehicle assemblies, an adhesive is applied to a base of the locking mount.

A vehicle assembly according to another exemplary aspect of the present disclosure includes, among other things, a vehicle body panel including an exterior surface and an interior surface, a mounting system including a locking mount and a structural patch arranged to secure the locking mount relative to the interior surface, and a vehicle component secured to the locking mount of the mounting system.

In a further non-limiting embodiment of the foregoing vehicle assembly, the vehicle body panel is an outer panel of a front fender or a rear quarter panel.

In a further non-limiting embodiment of either of the foregoing vehicle assemblies, the vehicle component is a vibration exciter.

In a further nom-limiting embodiment of any of the foregoing vehicle assemblies, a base of the locking mount is trapped between the structural patch and the interior surface of the vehicle body panel.

In a further nom-limiting embodiment of any of the foregoing vehicle assemblies, an adhesive is applied between the base and the interior surface.

In a further nom-limiting embodiment of any of the foregoing vehicle assemblies, a base of the locking mount is trapped between the structural patch and the interior surface of the vehicle body panel.

In a further nom-limiting embodiment of any of the foregoing vehicle assemblies, the locking mount includes a base and a collar that protrudes outwardly from the base.

In a further nom-limiting embodiment of any of the foregoing vehicle assemblies, the vehicle component includes a mounting base having a mating flange that is configured to engage a cam tab of the collar.

In a further nom-limiting embodiment of any of the foregoing vehicle assemblies, the vehicle component includes a mounting base having a mounting flange that includes a lip that is configured to engage a flexible prong of the collar.

In a further nom-limiting embodiment of any of the foregoing vehicle assemblies, the structural patch is a mastic patch or an adhesive patch.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a motor vehicle.

FIG. 2 schematically illustrates an exciter that can be mounted to a motor vehicle.

FIG. 3 illustrates a first side of a vehicle body panel.

FIG. 4 illustrates a second side of the vehicle body panel of FIG. 3.

FIG. 5 is a partial exploded view of a vehicle assembly that includes the vehicle body panel of FIGS. 3 and 4

FIG. 6 is a cross-sectional view through section 6-6 of FIG. 3.

FIG. 7 illustrates another exemplary vehicle assembly.

FIGS. 8A and 8B illustrate an exemplary locking mount of a mounting system.

FIG. 9 schematically illustrates an assembly method for assembling a vehicle assembly that includes a vehicle component, a mounting system, and a vehicle body panel.

### DETAILED DESCRIPTION

This disclosure details mounting systems for mounting a vehicle component to an interior surface of a vehicle body panel. An exemplary mounting system may include a locking mount that can be secured to the interior surface of the vehicle body panel by a structural patch. The vehicle component may be an exciter that can be secured to the locking mount to achieve positive contact relative to the vehicle body panel and achieve desired acoustic requirements for broadcasting audio signals. These and other features of this disclosure are described in greater detail below.

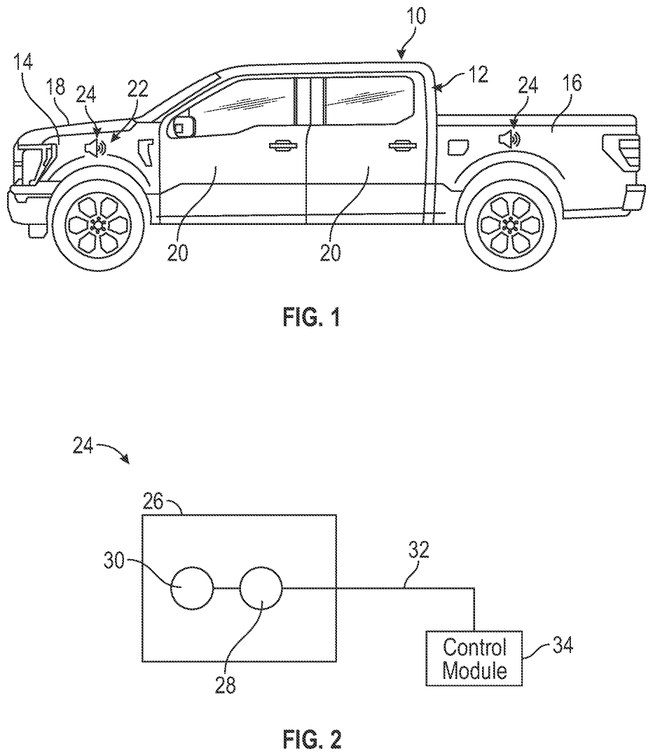

FIG. 1 schematically illustrates a motor vehicle 10 (hereinafter referred to simply as the “vehicle”). The vehicle 10 may be a pickup truck, a car, a van, a sport utility vehicle, a hearse, a semi tractor-trailer, or any other type of vehicle. The vehicle 10 could also be a conventional motor vehicle, a traction battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

The vehicle 10 includes a vehicle body 12. The vehicle body 12 may include a plurality of vehicle body panels. For example, the vehicle body 12 may include front side panels 14 (e.g., front fenders), rear side panels 16 (e.g., rear quarter panels), a hood panel 18, one or more closure member panels 20, etc.

The vehicle 10 may further be equipped with an acoustic vehicle alerting system (AVAS) 22 for communicating with passengers/users/pedestrians both inside and outside the vehicle 10. The AVAS 22 may include one or more exciters 24 (e.g., vibration exciters). The total number of exciters 24 provided on the vehicle 10 is not intended to limit this disclosure.

Each exciter 24 may be configured to broadcast audio signals to the outside of the vehicle 10 by vibrating corresponding portions of the vehicle body panel to which it is mounted. The audio signals may include a word or phrase, a chime or other sound effect, a series of sounds effects, or any combination of words and sounds effects, for example.

The exciter 24 may include a housing 26 with internal components such as a driver/actuator 28 and a voice coil 30 that are used to generate sound (see FIG. 2). The driver/actuator 28 can be a motor assembly, for example. The voice coil 30 may be coupled to one of the vehicle body panels of the vehicle body 12, which allows the vehicle body panel to act as an acoustic baffle of a speaker for amplifying sound. The exciter 24 may further include a wire connection 32 to a power source and a control module 34. The control module 34 may generate an electrical impulse signal that is transmitted to the exciter 24 to cause it to begin to vibrate at the frequency of the signal in order to broadcast audio signals to the surrounding environment. These vibrations may transfer through the vehicle body panel to radiate the desired audio signal.

The exciters 24 must be reliably mounted to the vehicle body 12 in order to function properly. However, many competing requirements are involved when deciding how and where to mount the exciters 24 relative to the vehicle body 12. These competing requirements may include but are not limited to acoustic requirements (e.g., the exciter 24 should be capable of efficiently transferring vibrations through the vehicle body panel to which it is mounted), studio requirements (e.g., the exciter 24 should not be visible from the exterior of the vehicle 10), operational requirements (e.g., the mounting strategy should not interfere with structural portions of the vehicle body panel or operations of nearby components), durability requirements (e.g., the mounting strategy should be robust enough to withstand operation in high repetition and extreme temperature situations), excitation requirements (e.g., the exciter 24 should not be constrained in a manner that eliminates range of movement), assembly requirements (e.g., the exciter 24 should accommodate tolerance variations and be easily and efficiently locatable and installable within the vehicle body 12), and/or serviceability requirements (e.g., the exciter 24 should be accessible and removable for servicing). This disclosure is therefore directed to mounting systems for reliably mounting exciters 24 or other types of vehicle components to vehicle body panels in a manner that addresses the foregoing requirements.

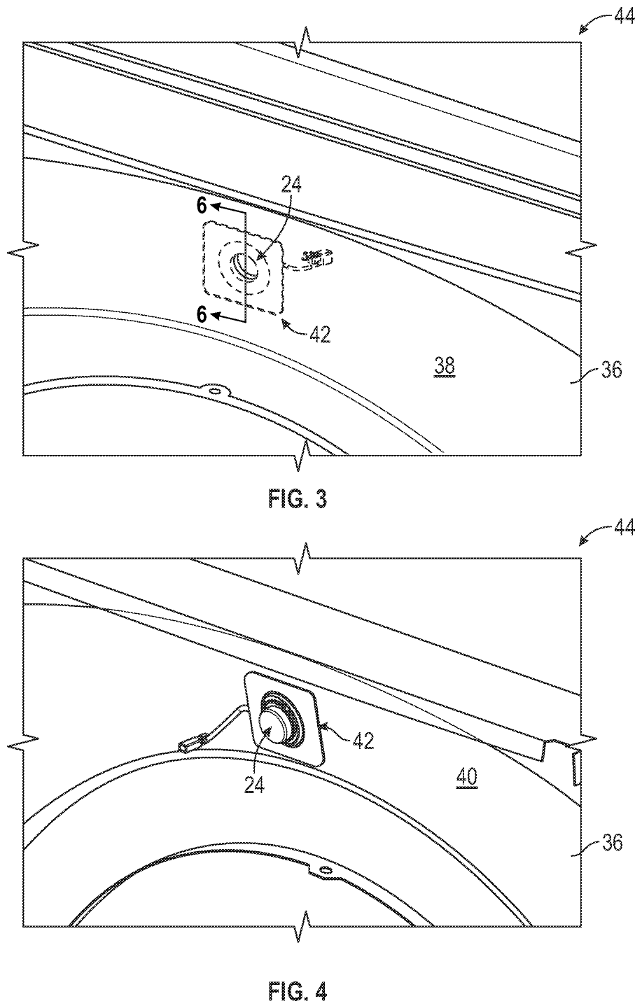

FIGS. 3 and 4, with continued reference to FIGS. 1-2, illustrate an exemplary vehicle body panel 36. In an embodiment, the vehicle body panel 36 is an outer panel of a front fender of the vehicle 10. However, the teachings of this disclosure could be extended to any vehicle body panel of the vehicle body 12.

The vehicle body panel 36 may include an exterior surface 38 (see FIG. 3, sometimes referred to as a class A surface) and an interior surface 40 (see FIG. 4, sometimes referred to as the B-side of the class A surface). An exciter 24 may be mounted to the vehicle body panel 36 by a mounting system 42. Together, the vehicle body panel 36, the exciter 24, and the mounting system 42 establish a vehicle assembly 44 of the vehicle 10.

In an embodiment, the exciter 24 is mounted directly to the interior surface 40 of the vehicle body panel 36 by the mounting system 42. The exciter 24 and the mounting system 42 are not visible when viewing the vehicle body panel 36 from a an environment that surrounds the exterior surface 38.

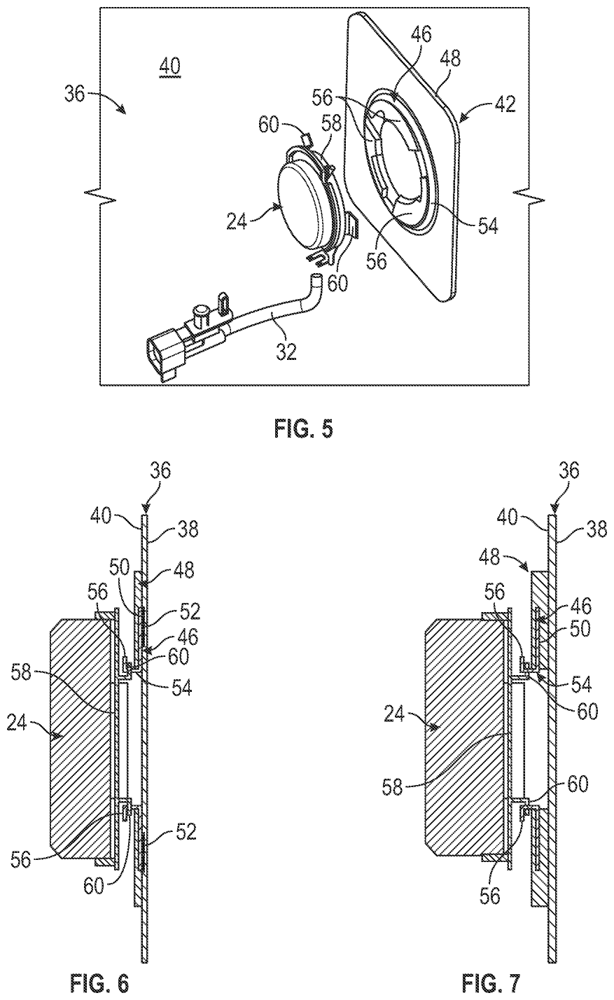

Referring now to FIGS. 5 and 6, the mounting system 42 may include a locking mount 46 and a structural patch 48. The locking mount 46 may be secured relative to the interior surface 40 of the vehicle body panel 36 by the structural patch 48.

In an embodiment, the structural patch 48 is a mastic patch. In another embodiment, the structural patch 48 is a peel-and-stick adhesive patch. Other types of structural patches could also be used and are therefore contemplated as being within the scope of this disclosure. Once the structural patch 48 is cured/stiffened, such as within a baking process during manufacturing and assembly, the structural patch 48 securely fixates the locking mount 46 to the vehicle body panel 36.

In an embodiment, a base 50 of the locking mount 46 is trapped between the structural patch 48 and the interior surface 40 of the vehicle body panel 36 (see FIG. 6). In such an embodiment, the base 50 of the locking mount 46 directly contacts the interior surface 40. An adhesive 52 may be applied between the base 50 and the interior surface 40 for augmenting attachment and reducing the required bearing load of the structural patch 48. The adhesive 52 may be a two-sided adhesive tape or any other suitable type of adhesive, for example.

In another embodiment, the base 50 of the locking mount 46 is embedded within the structural patch 48 (see FIG. 7). In such an embodiment, the base 50 of the locking mount 46 does not directly contact the interior surface 40 of the vehicle body panel 36.

The locking mount 46 may be configured a clocking lock ring mount that includes the base 50 and a collar 54 that protrudes outwardly from the base 50. The collar 54 may protrude outwardly in a direction away from the interior surface 40 in a mounted position of the locking mount 46.

The collar 54 may include a plurality of outwardly extending cam tabs 56 that are circumferentially spaced about the collar 54. A mounting base 58 of the exciter 24 may include a plurality of mating flanges 60. Each mating flange 60 may engage one of the cam tabs 56 in order to mount the exciter 24 to the locking mount 46 and therefore fixate the exciter 24 relative to the vehicle body panel 36. As the exciter 24 is moved (e.g., rotated) further into place, the mating flanges 60 may further engage the cam tabs 56 to provide a secure mounting arrangement. The total number of cam tabs 56 and mating flanges 60 provided could vary and is not intended to limit this disclosure. Once connected to the locking mount 46, the exciter 24 achieves positive contact with the vehicle body panel 36 for achieving desired acoustic requirements. The exciter 24 is thus appropriately arranged to vibrate the interior surface 40 for facilitating sound radiation to the exterior environment.

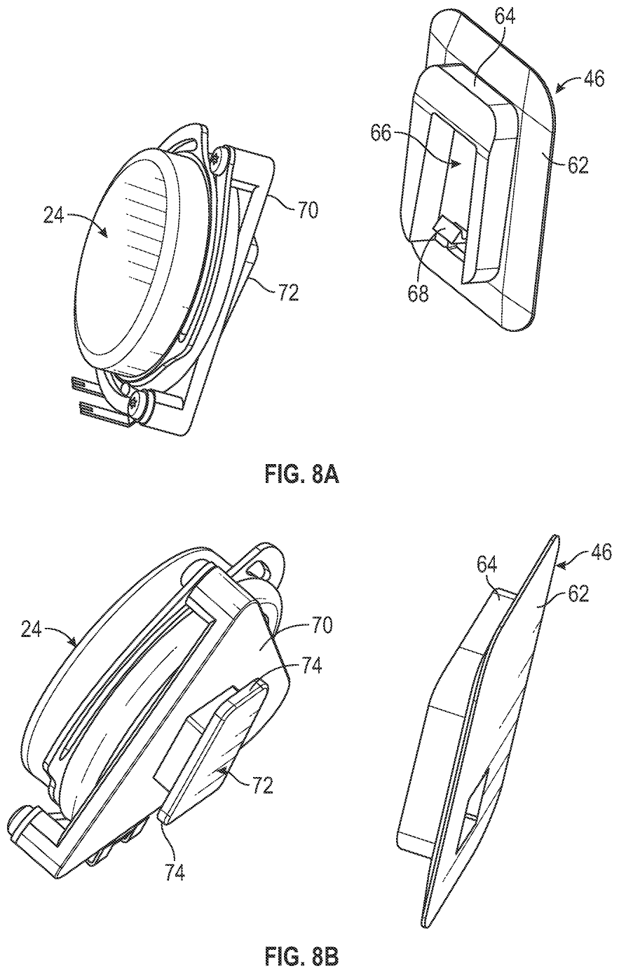

The mounting arrangement described above is a twist-in-place design. However, other implementations are possible. As shown in FIGS. 8A and 8B, for example, the locking mount 46 could alternatively provide a snap-in-place design. In this embodiment, the locking mount 46 may include a base 62 that can interface with the structural patch (not shown) and a collar 64 that protrudes outwardly from the base 62. A recessed portion 66 may be formed in the collar 64. One or more flexible prongs 68 may be provided within the recessed portion 66.

A mounting base 70 of the exciter 24 may include a mounting flange 72 having a pair of opposing lips 74. One lip 74 may be inserted into the recessed portion 66, and the mounting flange 72 may then be rotated downwardly in order to force the other lip 74 to engage the flexible prong 68 as the exciter 24 is moved further toward the locking mount 46 to snap-connect the exciter 24 to the locking mount 46. Once connected to the locking mount 46, the exciter 24 achieves positive contact with the vehicle body panel 36 for achieving desired acoustic requirements. The exciter 24 is thus appropriately arranged to vibrate the interior surface 40 for facilitating sound radiation to the exterior environment.

In the embodiments discussed above, the mounting system 42 is utilized to mount an exciter 24 to the interior surface 40 of the vehicle body panel 36. However, a person of ordinary skill in the art having the benefit of this disclosure would recognize that the mounting system 42 could be utilized to securely mount any type of vehicle component to the interior surface 40 of the vehicle body panel 36.

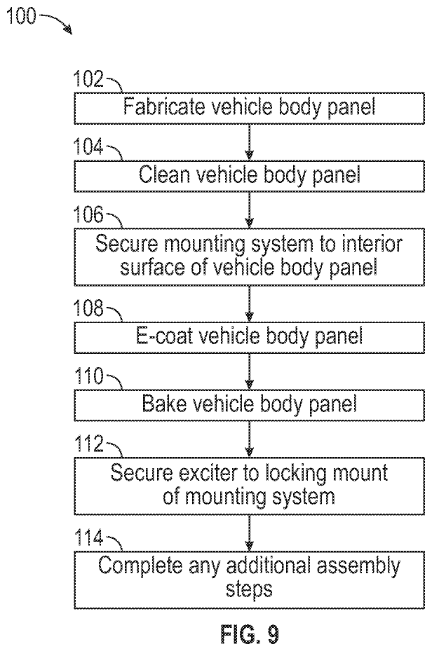

FIG. 9, with continued reference to FIGS. 1-8B, schematically illustrates an assembly method 100 for assembling the vehicle assembly 44. For example, the assembly method 100 can be employed for mounting the exciter 24 to the vehicle body panel 36 via the mounting system 42 of the vehicle assembly 44.

First, at block 102, the vehicle body panel 36 may be fabricated, such as in a stamping process, for example. The vehicle body panel 36 may then be cleaned at block 104.

Next, at block 106, the mounting system 42 may be secured to the interior surface 40 of the vehicle body panel 36. The mounting system 42 may be delivered to the final assembly plant as an assembly component, thereby simplifying the overall vehicle assembly process. The vehicle body panel 36 may then e-coated as part of an electro-deposition process at block 108.

Subsequent to being e-coated, the vehicle body panel 36 may be placed in an oven and then baked for a predefined amount of time as part of a baking process at block 110. The baking process cures the e-coating and also stiffens the structural patch 48 of the mounting system 42, thereby securely fixating the locking mount 46 relative to the interior surface 40 of the vehicle body panel 36.

The exciter 24 (or some other vehicle component) is next secured to the locking mount 46 at block 112. Positive contact between the exciter 24 and the vehicle body panel 36 is therefore achieved through the mounting system 42 for meeting desired acoustic requirements. Additional assembly steps associated with the vehicle body panel 36 (e.g., painting, etc.) may be performed at block 114 to complete the assembly method 100.

The mounting systems of this disclosure enable vehicle components to be securely fixated to the B-side of the class A surface of vehicle body panels. The components may be fixated to achieve robust contact with adjacent panel surfaces without the need for additional bracketry that is attached directly to the adjacent panel surfaces and without requiring weld nut attachments that could show through the class A surface. The proposed mounting systems further enable simple and efficient installation on the assembly floor during manufacturing.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a mounting system including a locking mount and a structural patch; and
a vehicle component mounted to the locking mount.

2. The vehicle assembly as recited in claim 1, wherein the mounting system is secured to an interior surface of a vehicle body panel.

3. The vehicle assembly as recited in claim 2, wherein the vehicle body panel is an outer panel of a front fender or a rear quarter panel.

4. The vehicle assembly as recited in claim 1, wherein the vehicle component is an exciter.

5. The vehicle assembly as recited in claim 1, wherein the locking mount includes a base and a collar that protrudes outwardly from the base.

6. The vehicle assembly as recited in claim 5, wherein the vehicle component includes a mounting base having a mating flange that is configured to engage a cam tab of the collar.

7. The vehicle assembly as recited in claim 5, wherein the vehicle component includes a mounting base having a mounting flange that includes a lip that is configured to engage a flexible prong of the collar.

8. The vehicle assembly as recited in claim 5, wherein the base is embedded within the structural patch.

9. The vehicle assembly as recited in claim 1, wherein the structural patch is a mastic patch or an adhesive patch.

10. The vehicle assembly as recited in claim 1, comprising an adhesive applied to a base of the locking mount.

11. A vehicle assembly, comprising:
a vehicle body panel including an exterior surface and an interior surface;
a mounting system including a locking mount and a structural patch arranged to secure the locking mount relative to the interior surface; and
a vehicle component secured to the locking mount of the mounting system.

12. The vehicle assembly as recited in claim 11, wherein the vehicle body panel is an outer panel of a front fender or a rear quarter panel.

13. The vehicle assembly as recited in claim 11, wherein the vehicle component is a vibration exciter.

14. The vehicle assembly as recited in claim 11, wherein a base of the locking mount is trapped between the structural patch and the interior surface of the vehicle body panel.

15. The vehicle assembly as recited in claim 14, comprising an adhesive applied between the base and the interior surface.

16. The vehicle assembly as recited in claim 11, wherein a base of the locking mount is trapped between the structural patch and the interior surface of the vehicle body panel.

17. The vehicle assembly as recited in claim 11, wherein the locking mount includes a base and a collar that protrudes outwardly from the base.

18. The vehicle assembly as recited in claim 17, wherein the vehicle component includes a mounting base having a mating flange that is configured to engage a cam tab of the collar.

19. The vehicle assembly as recited in claim 17, wherein the vehicle component includes a mounting base having a mounting flange that includes a lip that is configured to engage a flexible prong of the collar.

20. The vehicle assembly as recited in claim 11, wherein the structural patch is a mastic patch or an adhesive patch.
